(19) United States
(12) Patent Application Publication
(10) Pub. No.: US 2016/0073823 A1
(43) Pub. Date: Mar. 17, 2016

(54) PORTABLE CAMP STOVE

(71) Applicant: Charles E. Van Gelder, Ventura, CA (US)

(72) Inventor: Charles E. Van Gelder, Ventura, CA (US)

(21) Appl. No.: 14/484,364

(22) Filed: Sep. 12, 2014

(51) Int. Cl. A47J 37/07

(52) U.S. Cl. CPC A47J 37/0786

(57) ABSTRACT

A combination stove and tool box is provided for camping, with storage for cooking and eating tools, such as silverware, plates, utensils, pots, pans, hot pad holders, napkins, paper towels, and the like. The camping stove has a plurality of drawers for storing the tools, and one or more burners for cooking. The stove also includes a slide out shelf or cutting board, and add-on shelf, an interior light, and pivotal, recessed handles for carrying the stove. One or more biased members hold the lid in the open position. A fuel tank is removably coupled to the burners. A pivotal cover encloses the burners when not in use.

### BACKGROUND OF THE INVENTION

Portable stoves have been used for outdoor camping for many years. Typically, the stoves include a base which may have legs, one or more burners mounted in the base with a grate over each burner, a lid or cover hinged to the base to enclose the burners and grills for transport and storage, and a handle for carrying the stove. A fuel supply, such as a propane canister or tank can be connected to the burners for use. One goal of camping stoves is to be lightweight for easy carrying and storage. However, lightweight stoves typically do not have any storage capacity for tools and equipment needed for cooking and eating, such as pans, pots, spatulas, silverware, plates, hot pad holders, and the like. Some prior art camping stoves have very minimal storage capacity, which does not accommodate all the desired tools needed and used for cooking and eating.

Therefore, a primary objective of the present invention is a provision of a portable camping stove having substantial storage capacity for various cooking and eating tools.

Another objective of the present invention is the provision of a portable camping stove having a plurality of drawers to hold various items used for cooking and for eating.

Another objective of the present invention is the provision of a camping stove which is free from obstructions on the front of the stove during use.

Yet another objective of the present invention is the provision of a camping stove having a slide out shelf.

Yet another objective of the present invention is the provision of a camping stove having one or more additional shelves which can be mounted on at least one end of the stove.

A further objective of the present invention is the provision of a camping stove having a pivotal cover which, when closed, covers the burners while still allowing access to pull out storage drawers.

Another objective of the present invention is the provision of a combination camping stove and tool box for storage of cooking and eating tools.

Still another objective of the present invention is the provision of a portable camping stove having a light on the inside of the cover for use when the cover is open.

Yet another objective of the present invention is the provision of a portable camping stove having wind shields on opposite ends to block the wind during use of the stove.

A further objective of the present invention is the provision of a camping stove mounted in a box with storage capacity for cooking and eating utensils, plates, pots and pans, paper towel rolls and other accessories.

Yet another objective of the present invention is the provision of a camping stove having a lid which, when closed, covers the stove control knobs.

Yet another objective of the present invention is the provision of a camping stove with a propane tank that can be quickly and easily attached and detached to the stove burners, as needed.

A further objective of the present invention is the provision of an improved combination tool box and camping stove which is economical manufacture, lightweight, durable, and safe to use.

These and other objectives will become apparent from the following description of the invention.

### SUMMARY OF THE INVENTION

The portable camping stove includes a tool box with slide out drawers for storing various cooking and eating tools, such as utensils, silverware, pots, pans, plates, paper towels, hot pad holders, and other items. One or more burners are mounted in the box above the drawers, with a grate extending over the burner for cooking on the stove. A lid or cover is pivotally attached to the box for movement between open and closed positions. When the lid is closed, the box and stove form an integral assembly without extra panels or doors which must be closed or locked. The drawers, when closed, allows a user to stand in front of the stove without any other obstructions. The stove may include additional features, such as an add-on side shelf, an interior light, a quick-coupler fuel tank, a slide out shelf, one or more gas cylinders to maintain the lid in an open position, and recessed handles for carrying the stove and tool box combination.

### BRIEF DESCRIPTION OF THE DRAWINGS

FIG. 1 is a perspective view of the portable camping stove according to the present invention, with the lid in an open position.

FIG. 2 is a perspective view of the camping stove with the lid in a closed position.

FIG. 3 is a front elevation view of the camping stove, with the lid in an open position.

FIG. 4 is a rear elevation view of the stove, with a lid in an open position.

FIGS. 5 and 6 are elevation views from the opposite sides of the stove, with the lid in an open position.

FIG. 7 is a top plan view of the stove, with a lid in an open position.

FIG. 8 is a bottom plan view of the stove.

FIG. 9 is a perspective view of the stove with an optional grill mounted on one end.

FIG. 10 is a perspective view of the stove with an optional water basin mounted on one end.

FIG. 11 is a perspective view of the stove with a slide out shelf.

FIG. 12 is a perspective view of the stove showing the silverware tray in one drawer.

FIG. 13 is a rear perspective view of the stove showing the fuel tank mounted for use.

### DETAILED DESCRIPTION OF THE PREFERRED EMBODIMENTS

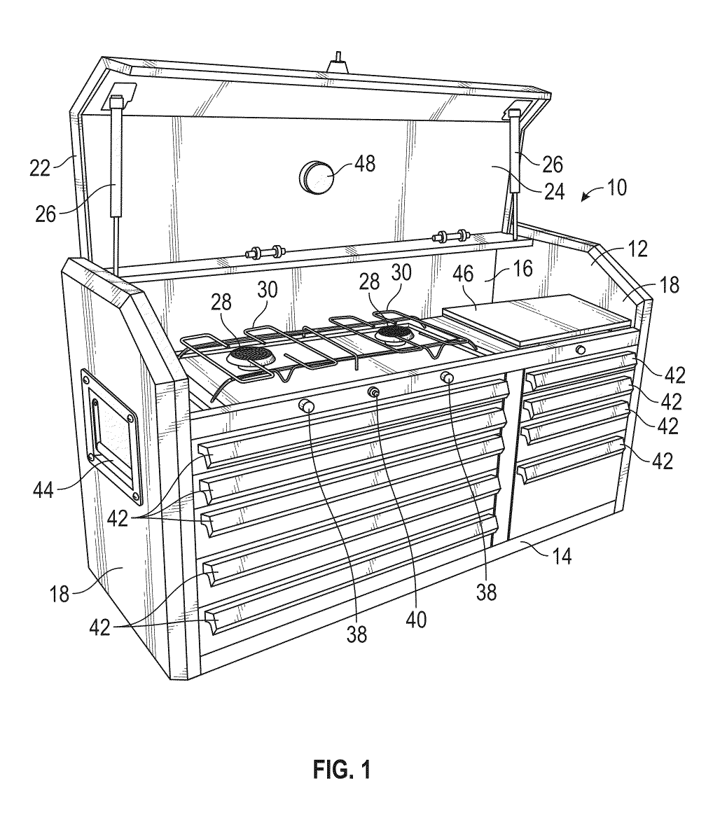

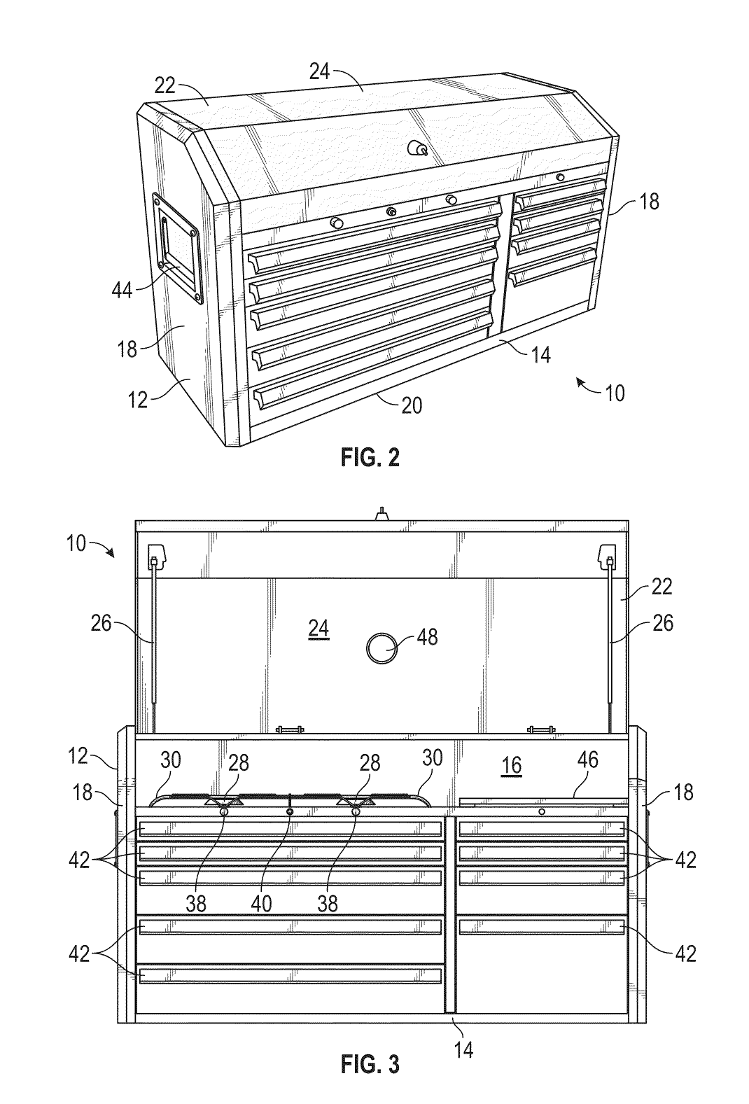

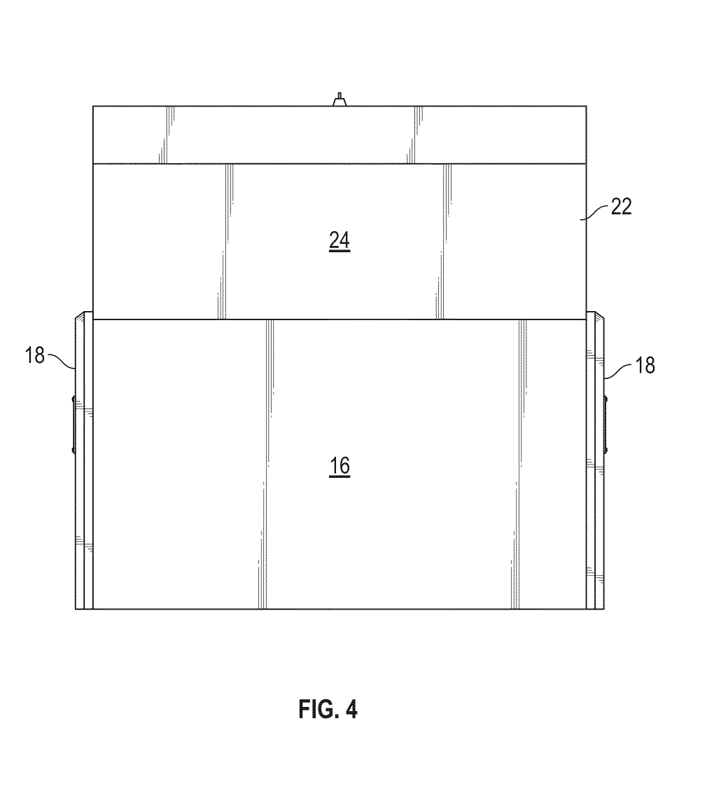

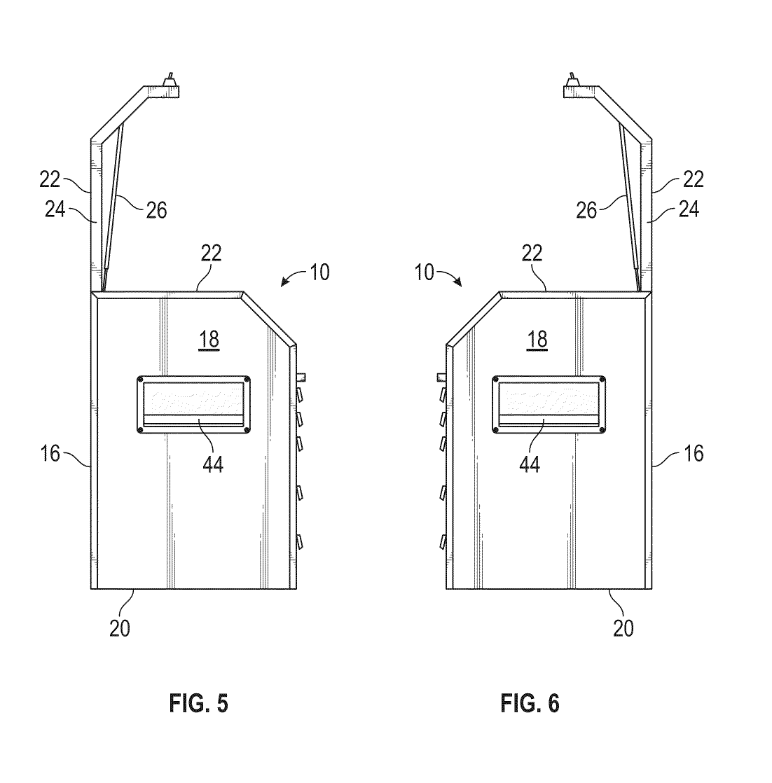

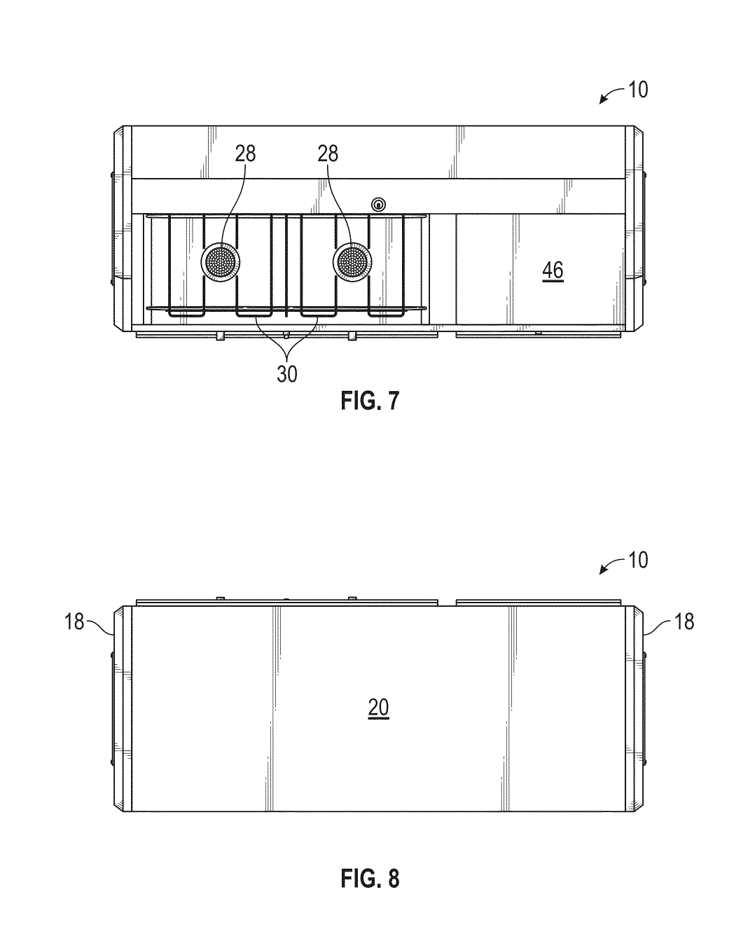

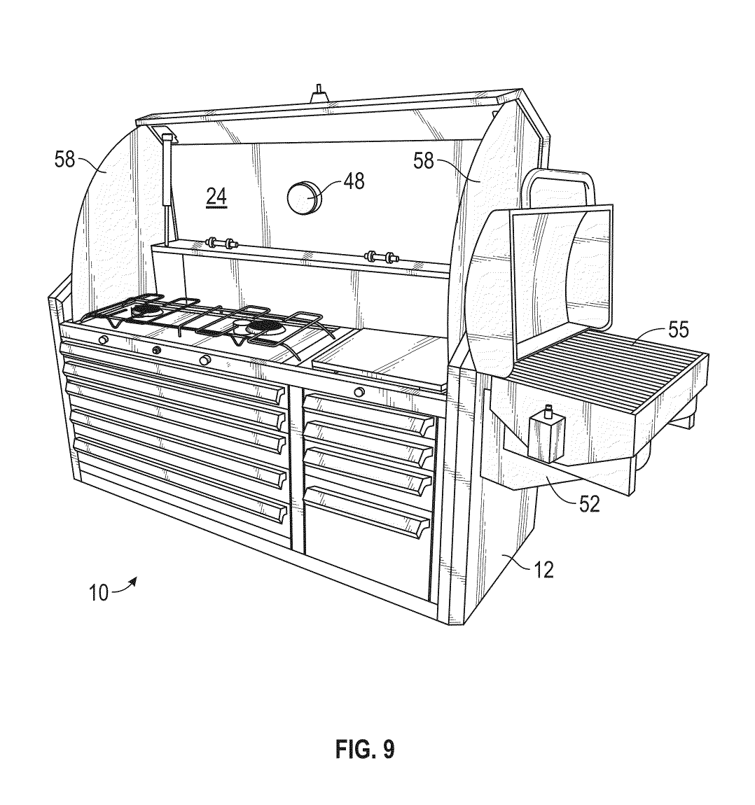

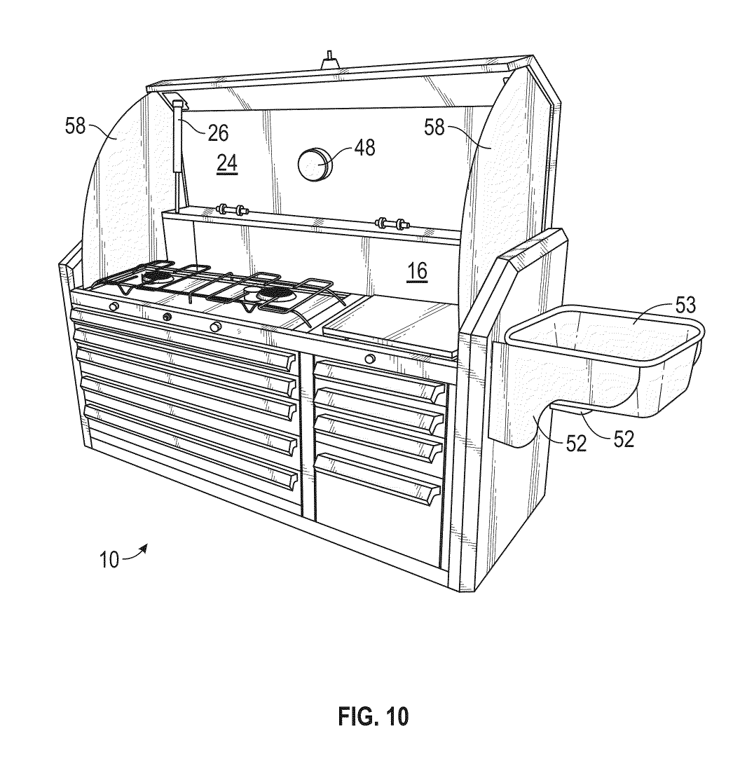

The portable camping stove and tool box combination of the present invention is generally designated by the reference number 10 in the drawings. The stove 10 includes a box 12 having a front 14, a back 16, opposite sides 18, a bottom 20, and a top 22 formed by a cover or lid 24 which is hinged to the back 16 of the box 12 for movement between an open position shown in FIG. 1 and a closed position shown in FIG. 2. The cover 24 includes a pair of gas cylinders 26 with an extendable arm to hold the cover 24 in the open position. While FIG. 1 shows a pair of cylinders 26, it is understood that a single cylinder can be used, or alternatively, a spring biased hinge, or other support arm to maintain the cover 24 in the open position for use of the stove 10.

One or more burners 28 are mounted within the box 12 below the top edge. The cover 24 has a top panel and a front panel to cover the burners 28 when the cover is closed. A grate 30 is provided over each burner 28. The burners 28 are connected to a fuel source, such as a propane tank 32. In a preferred embodiment, the propane tank 32 is threadably coupled to the burner fuel lines (not shown) via a connector or coupler 34 extending through a hole 36 in the back 16 of the box 12, and supported by a bracket 37 removably mounted on the back wall 16. For example, the bracket edge may include hooks for reception slots in the back wall 16. The coupler 34 can be threadably attached to the burner fuel lines, or a quick coupler attachment can be utilized. A control knob 38 is provided on the front 14 of the box 12 for each burner 28. A push button ignition 40 is also provided on the front 14 of the box 12 to light the burners 28. In one embodiment, the control knobs 38 and the ignition button 40 are behind the front panel of the cover 24 when the cover is closed.

The stove 10 also includes a plurality of slide out drawers 42 in the box 12. The drawers 42 can have various configurations and dimensions, beyond those shown in the drawings. The drawers 42 are sized so as to hold various cooking and eating tools, such as utensils, silverware, pots, pans, hot pad holders, plates, napkins, paper towels, and other items. The drawers 42 can be opened while the cover 24 is closed for loading and unloading of the cooking and eating tools. In the preferred embodiment, a lock mechanism is provided on the stove 10 so that the drawers 42 can be locked in the closed position when the cover 24 is closed, thereby providing accidental opening of the drawers when the stove is being carried to or from a campsite.

A handle 44 is provided on each side or end 18 of the box 12. Preferably, the handles 44 are pivotally attached to the box 12 for movement between a folded storage position and an unfolded used position. Also, the handles 44 are preferably recessed into the box 12 when folded down so as to not protrude from the sides 18 of the box 12.

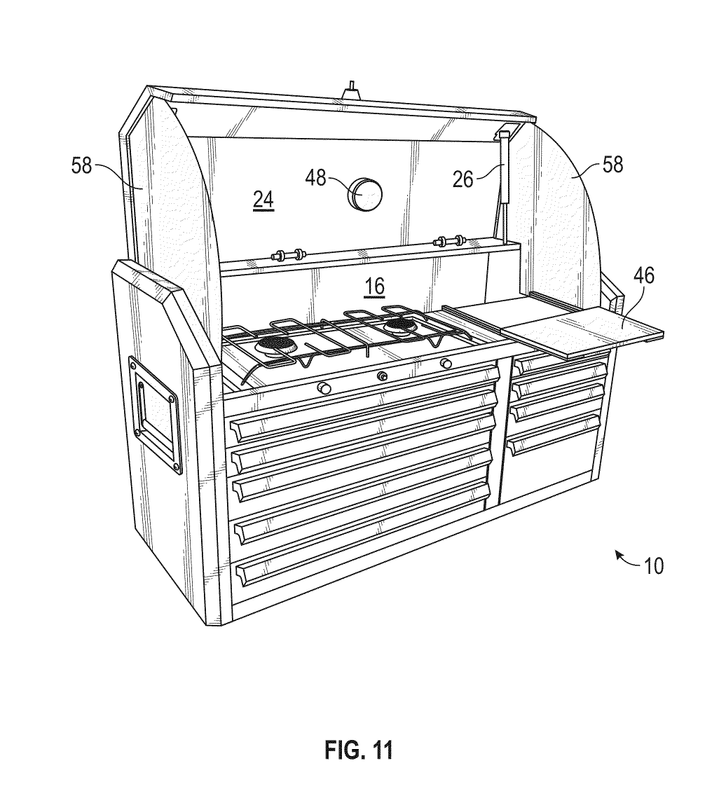

The stove 10 may include other features for added utility. For example, a shelf or cutting board 46 can be provided within the box 12 adjacent the burner grates 30. The shelf/cutting board 46 may be mounted on slide out brackets so that the shelf 46 can be pulled forwardly so as to extend beyond the front 14 of the box 12, as shown in FIG. 11.

Another optional feature is a light 48 mounted in the cover 24. The light 48 is battery powered and includes any type of convenient switch for turning the light on and off. Another optional feature is an add-on shelf on one end of the box 12. The add-on shelf includes a pair of support brackets 52 having hooks which are received through corresponding slots in the side 18 of the box 12. Alternatively, the brackets 52 can be hinged to the side 18 for movement between a folded storage position adjacent the side 18 and an unfolded use position extending outwardly from the side 18. The brackets 52 and/or shelf 50 can support various objects, such as a wash basin 53, a small grill 55, condiments, plates, napkins, and silverware.

Another optional feature is a paper towel holder inside one of the drawers for supporting a roll of paper towels. For example, a rod may extend through the roll of paper towel and have opposite ends received in corresponding holes and slots on the inside of one of the drawers 42.

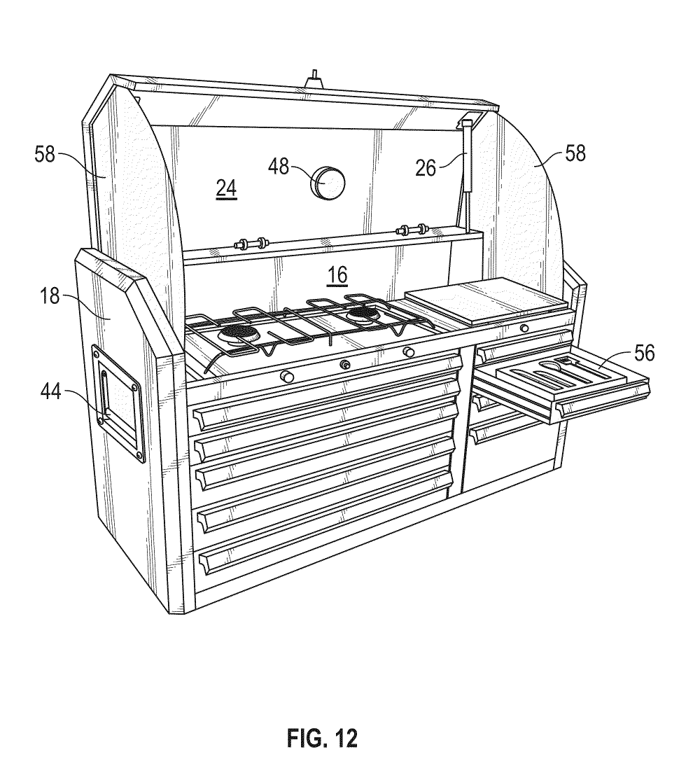

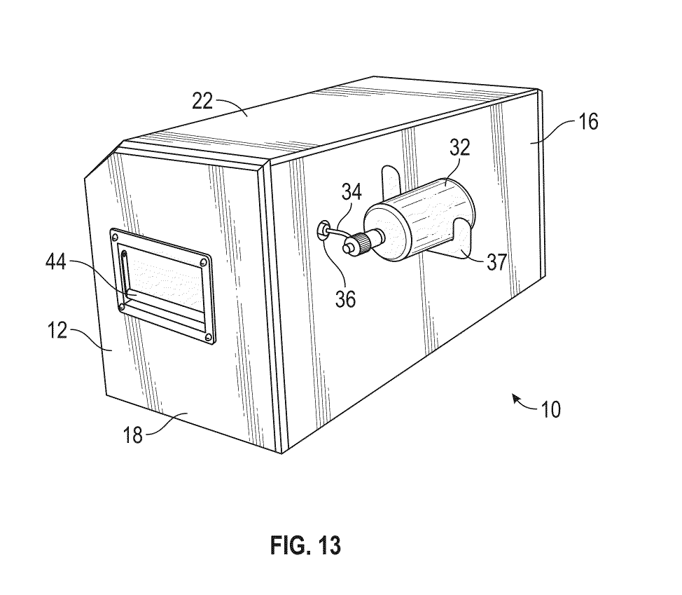

One of the other drawers can also include a silverware tray 56 with dividers for the forks, knives, and spoons, as shown in FIG. 12.

Another optional feature is wind shields 58 which are position on opposite ends of the box 12 when the cover 24 is in the open position. The wind shields 58 may be separate from the box 12 and lid 24, with any convenient mechanism to retain the wind shields in an upright position during use, and easily stored in one of the drawers 42 when not in use. Alternatively, the wind shields 58 can be mounted to the cover 24 to automatically move into position when the cover is open, and extend downwardly through slots (not shown) inside the end walls of the box 12 when the cover 24 closed. The wind shields 58 minimize win turbulence around the burners 28 when the burners are turned on.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A portable camping stove assembly, comprising:
a box with a front, a back, opposite sides, and a bottom;
a top cover pivotally mounted to the box for movement between open and closed positions;
a burner mounted in the box for cooking;
a plurality of drawers mounted in the box beneath the burner for storage of cooking and eating supplies;
the drawers forming a front panel substantially closing the front of the box when the drawers are closed.

2. The portable camping stove of claim 1 wherein the drawers are lockable in a closed position.

3. The portable camping stove of claim 1 further comprising a push button ignition on the front of the box and operatively connected to the burner.

4. The portable camping stove of claim 1 further comprising a pull out shelf adjacent the burner.

5. The portable camping stove of claim 1 further comprising a silverware tray in one or the drawers.

6. The portable camping stove of claim 1 further comprising wind shields attached to opposite sides of the cover to block the burner from side wind when the cover is open.

7. The portable camping stove of claim 1 further comprising support brackets mounted on one side of the box to support a cooking accessory.

8. The portable camping stove of claim 1 further comprising a fuel canister mounted on the box, and a fuel line connecting to the canister to the burner.

9. The portable camping stove of claim 1 further comprising an extendable cylinder to hold the cover in the open position.

10. The portable camping stove of claim 1 further comprising handles on the opposite sides of the box for carrying the camping stove.

11. The portable camping stove of claim 1 further comprising a light mounted inside the cover.

12. A camping stove, comprising:
a housing;
a cover on the housing pivotal between open and closed positions;
a plurality of drawers in the housing slidable between open and closed positions;
a burner mounted in the housing above the drawers;
the housing, the cover, and the drawers forming an enclosed box when the cover and drawers are closed to protect the burner and contents of the drawers from the weather.

13. The camping stove of claim 12 further comprising a pull out shelf in the box adjacent the stove.

14. The camping stove of claim 12 further comprising wind shields attached to opposite sides of the cover to block the burner from side wind when the cover is open.

15. The camping stove of claim 12 further comprising support brackets pivotally on one end of the box to support a cooking accessory.

16. A combination stove and tool box, comprising:
a box having a plurality of drawers for storing cooking and eating tools;
a stove operatively mounted within the box above the drawers for cooking food.

17. The combination stove and tool box of claim 16 wherein the box and stove form an integral assembly.

18. The combination stove and tool box of claim 16 further comprising a pivotal cover on the box movable between a closed position over the stove and an open position spaced from the stove.

19. The combination stove and tool box of claim 16 wherein the stove resides below a top edge of the box.

20. The combination stove and tool box of claim 19 wherein the cover is hinged to the top edge, and the cover has perpendicular panels forming a top of the box and a partial front of the box when the cover is in the closed position.
